(19) United States
(12) Patent Application Publication
(10) Pub. No.: US 2007/0095448 A1
(43) Pub. Date: May 3, 2007

(54) Anti-skid spike

(76) Inventors: Rainer Krahl, Schramberg (DE); Stefan Roth, Aichhalden (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/559,149

(22) PCT Filed: Jul. 1, 2004
(86) PCT No.: PCT/EP04/07171

§ 371 Date: Dec. 27, 2006

(30) Foreign Application Priority Data
Jul. 2, 2003 (DE) 103 29 997.1

(51) Int. Cl. B60C 11/00

(52) U.S. Cl. 152/210

(57) ABSTRACT

An anti-skid spike which may be applied to an embedded opening on a running surface of, for example, a tire, having an insert piece and a base body with a molded flange and a recess for housing the insert piece. According to this invention, material and shape combinations not previously applied or possible can be achieved, whereby a housing selection is formed on the base body, at least partly enclosed by at least one sleeve piece and, in an assembled state, the sleeve piece is arranged at least partly in the region around the recess.

### BACKGROUND OF THE INVENTION

1. Field of the Invention

This invention relates to an anti-skid spike which can be inserted into an embedding opening in a tread surface, for example of a tire, having an insertion element made of a hard alloy and a base body with a flange and a recess for the insertion element, wherein the insertion element inserted into the base body protrudes beyond the base body.

2. Discussion of Related Art

An anti-skid spike is known from French Patent Reference FR 2 775 934 A. An insertion element made of a hard alloy is inserted into a receiver element having a softer material, wherein the unit of receiver element and insertion element is then inserted into the recess of the base body. The insertion element must be held in a positively and non-positively connected manner, and it is also necessary for the receiver element to also be fixed in place in the base body. Only in this way is it possible to assure that the connection between the three elements is unequivocally fixed in place, which is not always assured, particularly if the insertion element has a cone-shaped section.

The three-piece anti-skid spikes in accordance with German Patent Reference DE 21 17 151 A and PCT International Application WO 02/070287A1 have similar disadvantages.

### SUMMARY OF THE INVENTION

It is one object of this invention to provide an anti-skid spike of the type mentioned above but wherein the fixation in place of the insertion element in the base body is achieved with improved holding.

In accordance with this invention, the above object is attained with a base body that forms a receiver section which extends at least in part around the recess in the base body. A sleeve element is applied on the receiver section, which fixes the insertion element inserted into the recess of the base body in it in a positive and non-positive manner.

The insertion element can be easily inserted into the base body. Then the sleeve element is applied to the receiver section of the base body, wherein the dimensions of the sleeve element determine the application force, and thus the hold of the insertion element in the recess of the base body. In spite of this, the sleeve element is easily accessible and can be pressed on the receiver section of the base body.

As customary, in this arrangement the base body also holds the insertion element. In this case, the base body can be designed with a selection of its material and/or functioning such that a good fixation in place of the insertion element results. The sleeve element fixes the connection between the base body and the insertion element. It is thus possible to establish a stable connection of the total system. If desired, it is also possible to match the sleeve element to its material properties to the wear properties of the entire system. It is possible, for example, for the base body to be made of a more easily wearing material. The total system can have the required wear properties with the sleeve element made of a more wear-resistant material.

If appropriately laid out, the sleeve element can stabilize the base body against lateral bending, so that materials other than those used up to now, and possibly also more cost-effective ones, can be used for the base body.

In one embodiment, in the assembled state the insertion element projects beyond or past the sleeve. Thus, in operation the insertion element is pushed into the snow or ice and clearly increases the interlock of the tire with the ground, and therefore the force which can be transferred.

A particularly easy assembly of the insertion element, simultaneously along with a solid connection with the base body, is achieved if the insertion element has a cone-shaped section which, in the assembled state, engages a corresponding recess in the base body, and a positive or non-positive connection between the sleeve element and the receiver section of the base body is formed.

If the insertion element is made of a hard material, preferably a hard alloy, and the sleeve element of a material of lesser wear resistance in comparison with the insertion element, then it is possible for the insertion element and the material of the tire to have wear properties which are matched so that during operations the length of the insertion element protruding with respect to the tire is substantially maintained and the sleeve element and the tread wear at the same rate. The insertion element thus has the same anti-skid effect over its entire life.

In a cost-effective embodiment, the base body is made of a material which is less wear-resistant in comparison with the insertion element and the sleeve element, because the base body definitely determines the material costs due to the large proportion of its volume with respect to the entire component.

A particularly solid and permanent seating of the sleeve element is achieved if the sleeve element is embodied as a closed ring resting on the entire surface of the receiver section of the base body, as a ring partially resting in segments on it, or as a clamping sleeve in the form of a slit ring.

In one embodiment, the sleeve element has a bezel at one or both of its ends on the longitudinal side, which encircles it at least partially. With the bezel which faces the tread surface during the assembly process of the anti-skid spike, the sleeve element slides easily into the assembly opening, the roll-off properties are improved by the other bezel, and the noise generation is reduced. A construction of the sleeve element with bezels of identical geometry on both sides is advantageous, because there is no possible confusion when assembling the sleeve on the receiver section.

A particularly cost-effective and simple to assemble embodiment of the sleeve element has the sleeve element constructed to be rotationally symmetrical.

A particularly good sealing effect of the sleeve element in the tread surface is achieved if the base body has a flange formed on it, and the diameter of the sleeve element is greater than the diameter of the flange of the base body. The anti-skid spike has seating which is stable against tilting because of the large diameter of the sleeve element, so that its anti-skid effect is improved.

A simple and cost-effective manufacture is achieved if the receiver section of the base body and the passage in the sleeve element corresponding to it are designed cylindrical. If the receiver section of the base body and the passage in the sleeve element corresponding to it are designed to be in the form of a truncated cone, it is possible to achieve a solid connection between the base body and the sleeve element even with large manufacturing tolerances. Solid seating of the sleeve element, along with a cost-effective base body, is achieved if the receiver section of the base body is designed cylindrical, and the corresponding passage of the sleeve element is designed in the form of a truncated cone which opens in the direction of the tread surface, because the insertion of the insertion element leads to the base body opening in the shape of a mushroom and to effectively preventing the release of the sleeve element. An embodiment which absorbs manufacturing tolerances and simultaneously assures a solid connection provides for the receiver section of the base body to initially have a section in the shape of a truncated cone and a cylindrical section following it, wherein the passage in the sleeve element has an area which corresponds to the truncated cone-shaped section of the receiver section, which is followed by a conically widened expansion depression.

A defined assembly of the sleeve element on the base body, and therefore a well defined effect of the anti-skid spike, is achieved if a detent in the form of a protrusion is provided between the receiver section and the flange of the base body.

If the receiver section of the base body has a snap-in element, which in the assembled state engages a snap-in receiver of the sleeve element, it is possible to assemble the sleeve with comparatively small effort, and simultaneously effectively fix the sleeve in place, because the insertion element spreads apart and secures the snap-in elements of the base body.

In one embodiment the receiver section of the base body has a snap-in element and at least one slit-shaped recess in the longitudinal direction of the receiver section. In the assembled state the snap-in element engages a snap-in receiver of the sleeve element. Thus during assembly the snap-in element of the base body can be displaced over a particularly large distance and therefore can engage the snap-in receiver particularly deeply and securely.

If the sleeve element is designed as a multi-part element, and if the sleeve has at least one further ring sleeve element, the sleeve element on the inside can be made of a less wear-resistant cost-effective material, and the ring sleeve element of the higher value material otherwise required for the entire shell element.

Improved seating of the anti-skid spike in the tire material, which is more resistant to being torn out, is achieved if the sleeve element has a radially outward protruding flange and/or the base body has at least one further flange.

An improved anti-skid effect of the anti-skid spike is achieved if in the assembled state the insertion element is set back with respect to the sleeve element, and the sleeve element protrudes with respect to the tread surface. The sleeve element, which in this embodiment is made of a hard material or other suitable material, is more wear-resistant because of the larger surface and can dig into snow or ice particularly well because of the slight lateral tilting occurring under a load by lateral forces.

### BRIEF DESCRIPTION OF THE DRAWINGS

This invention is explained in greater detail in view of the exemplary embodiments represented in the drawings, each in a partial section and respectively in a disassembled state in an upper portion of the figures and in an assembled state in a lower portion of the figures, wherein:

FIG. 1 shows an anti-skid spike with a base body with a cylindrical receiver section;

FIG. 2 shows an anti-skid spike in accordance with FIG. 1 but with a widened sleeve element;

FIG. 3 shows an anti-skid spike with a base body with a receiver section, which has a section in a shape of a truncated cone;

FIG. 4 shows an anti-skid spike with a sleeve element and a conical passage opening in the direction toward the tread surface;

FIG. 5 shows an anti-skid spike with a snap-in element on a receiver section of the base body;

FIG. 6 shows an anti-skid spike with a slit-shaped recess in an area of a receiver section of the base body;

FIG. 7 shows an anti-skid spike with a sleeve element which has an expansion depression;

FIG. 8 shows an anti-skid spike with a sleeve element and an additional ring sleeve element;

FIG. 9 shows an anti-skid spike with a sleeve element protruding with respect to a tread surface and embodied as a wear element; and

FIG. 10 shows an anti-skid spike with a base body which has two flanges but only shown in an assembled state.

### DESCRIPTION OF PREFERRED EMBODIMENTS

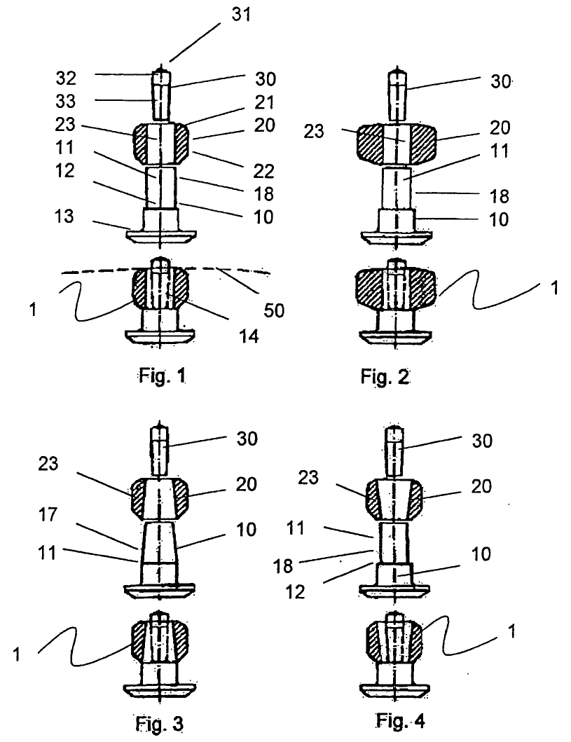

An anti-skid spike 1, such as can for example be inserted into an embedding opening of a tread surface 50 of a tire, is shown in FIG. 1. The anti-skid spike 1 has a base body 10, which has at least one flange 13 formed on one end. In the area of or near the flange 13, the base body 10 has a detent 12, and at the other end a receiver section 11. The flange 13 is used for anchoring the base body 10 inside the embedding opening of the tire. The receiver section 11 is used for receiving a sleeve element 20, which extends at least partially around the receiver section 11 and has a passage 23 corresponding to the receiver section 11. Here, the position of the sleeve element 20 on the receiver section 11 of the base body 10 is determined by the detent 12. The receiver section 11 also has a recess 14, not visible in the upper part of the figure, which is used for receiving an insertion element 30 such that in the assembled state the sleeve element 20 is arranged in the area around the recess 14. In the assembled state, the insertion element 30 protrudes beyond or past the sleeve element 20.

The insertion element 30 is designed as a pin and has a pinhead 31, adjoining that a cylindrical section 32 and a cone-shaped section 33 which, in the assembled state, engages the corresponding recess 14 of the base body 10 so that a positive or non-positive connection between the inner surface of the passage 23 of the sleeve element 20 and the circumferential surface of the receiver section 11 of the base body 10 is formed.

The sleeve element 20 can be embodied as a closed ring, resting with its entire surface against the receiver section 11 of the base body 10, as a ring which partially rests against it in segments, or as a clamping sleeve in the form of a slit ring. In the example shown, the sleeve element 20 has a circumferential bezel 21, 22 at one or both of its longitudinal ends, and is preferably constructed to be rotationally symmetrical. In the assembled state it preferably terminates at the tread surface 50. The bezel 22 is used to reduce the force required for assembling the anti-skid spike 1 in the tire material. The bezel 21 ensures that the roll-off noise is reduced. The bezels 21, 22 are preferably embodied identical with respect to their geometry, which prevents confusion when assembling the sleeve element 20 on the base body 10.

In the example shown, the insertion element 30 is made of a hard material, preferably a hard alloy. In comparison to the insertion element 30, the sleeve element 20 is made of a less wear-resistant material. The wear properties of the materials of the insertion element 30 and the sleeve element 20, as well as the material of the tire, are matched to each other so that during operation the length of the insertion element 30 protruding beyond or past the tread surface 50 is substantially maintained, and the sleeve element 20 and the tread surface 50 wear at the same rate. The base body 10 can be made of a material which is less wear-resistant in comparison with the insertion element 30 and the sleeve element 20. Plastic, sintered materials, ceramic materials, for example aluminum oxide, aluminum or other suitable material can be used as the material for the base body 10.

FIG. 2 shows an embodiment in accordance with FIG. 1, wherein the diameter of the sleeve element 20 is greater than the diameter of the flange 13 of the base body 10. An improved support of the anti-skid spike 1 within the insertion opening is thus achieved. Bending forces are distributed more evenly. Here, too, the receiver section 11 of the base body 10 preferably has a cylindrical section 18.

In comparison with the embodiments represented in FIGS. 1 and 2, the embodiment shown in FIG. 3 has a receiver section 11 of the base body 10 with a section 17 in the shape of a truncated cone. The passage 23 of the sleeve element 20 has a corresponding geometry. A self-locking geometry is thus achieved, which is particularly manufacturing-tolerant.

In contrast to the embodiments so far described, the embodiment in FIG. 4 has a receiver section 11 with a preferably cylindrical section 18 and a detent 12. By comparison, the sleeve element 20 has a passage 23 in the form of a truncated cone, which is embodied to open in the direction toward the tread surface 50. In the assembled state, when the insertion element 30 is inserted into the recess 14, the passage 23 receives the radially expanding material of the receiver section 11 and forms a positive or non-positive connection between the sleeve element 20 and the base body 10.

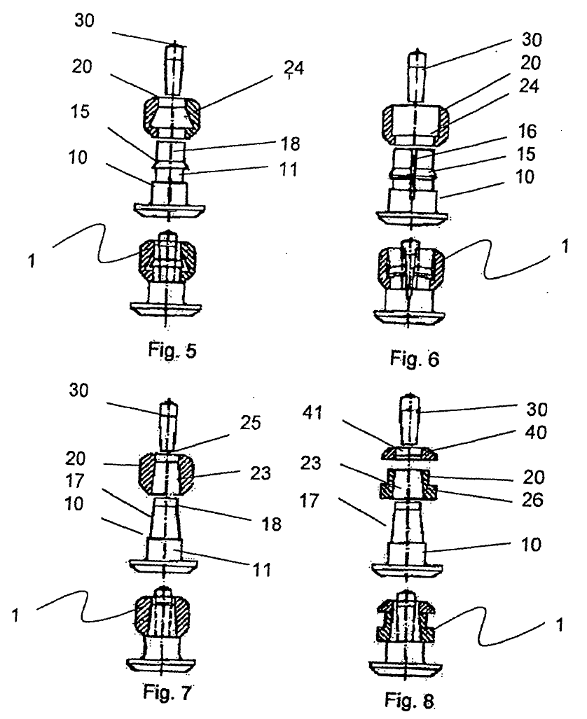

In a further embodiment, such as shown in FIG. 5, a snap-in element 15 in the area of or near the receiver section 11 of the base body 10 which, in the assembled state, engages a snap-in receiver 25 of the sleeve element 20 and fixes it in place rotatable or fixed. When inserting the insertion element 30 into the recess 14 the material of the receiver section 11 is radially stretched and is supported against the cylindrical portion of the passage 23 above the snap-in receiver 24 and thus clamps the sleeve element 20 to the base body 10.

Here, the snap-in element 15 and/or the sleeve element 20 are laid out to be flexible in the area of the snap-in connection. The use of flexible materials is also preferably conceivable, for example plastic materials. It is also possible to use a snap-in element in the form of a resilient collar as a mounted spring element. The receiver section 11 can have a recess for receiving the snap-in element 15, to prevent shifting on the receiver section 11. The snap-in receiver 24 inside the passage 23 can also be embodied as a separate snap-in insert, which is first inserted into the passage 23.

In the area of or near the receiver section 11 of the base body 10, the embodiment shown in FIG. 6 has a snap-in element 15 and at least one slit-shaped recess 16 in the longitudinal direction of the receiver section 11. When the insertion element 30 is inserted into the recess 14 of the base body 10, the slit area of the receiver section 11 is widened. In the process, the snap-in element engages a corresponding snap-in receiver 24 in the sleeve element 20, to achieve a solid connection between the base body 10, sleeve element 20 and insertion element 30 in accordance with the mushrooming principle.

The embodiment of the anti-skid spike 1 shown in FIG. 7 has a base body 10 with a receiver section 11 with an initially truncated cone-shaped section 17 and an adjoining cylindrical section 18, wherein the passage 23 of the sleeve element 20 has an area corresponding to the truncated cone-shaped section 17, which is followed by a conically widening extension depression 25. In the assembled state, the material of the cylindrical section 18 of the receiver section 11 is radially pressed into the extension depression 25 by the insertion of the insertion element 30, to make the connection between the base body 10, the sleeve element 20 and the insertion element 30.

In FIG. 8, the sleeve element 20 from FIG. 7 is in two parts and has an additional ring sleeve element 40. The ring sleeve element 40 has a conical bore 41. In its design, the base body 10 corresponds to the base body in FIG. 7 and also has a section 17 in the shape of a truncated cone and an adjoining cylindrical section 18 at the receiver section 11. In the assembled state, the material of the cylindrical section 18 of the receiver section 11 is radially pressed into the conical bore 41 of the ring sleeve element 40 by the insertion of the insertion element 30, to make the connection between the base body 10, the sleeve element 20, the ring sleeve element 40 and the insertion element 30.

In the embodiment represented, the sleeve element 20 has a radially outward protruding flange 26, which provides additional anchoring of the anti-skid spike 1 in the tread surface 50.

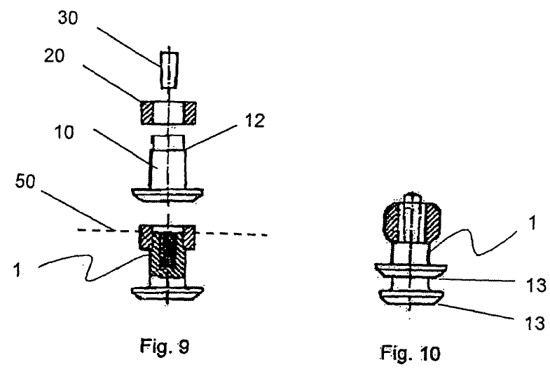

FIG. 9 shows an embodiment of the anti-skid spike 1 wherein the insertion element 30 is set back in the assembled state with respect to the sleeve element 20, and the sleeve element protrudes with respect to the tread surface 50. In this case the sleeve element 20 is made of a wear-resistant material, preferably a hard alloy. Thus, the sleeve element can dig better into the surface of snow or ice because of the slight lateral tilting occurring under a load by lateral forces.

As shown by example in FIG. 10, the base body 10 can also have two or more flanges 13, which improve anchoring in the embedding opening of the tread surface 50.

The embodiments shown are based on an assembly arrangement wherein the insertion element 30 is inserted into the side of the receiver section 11 of the base body 10 from the side facing away from the flanged side of the base body 10. However, embodiments are also possible wherein the insertion element 30 can be inserted from the direction of the flanged side of the base body 10. It is also possible to either first assemble the insertion element 30 in the recess 14 in the receiver section 11, and then the sleeve element 20 over the receiver section 11 or, vice versa, first the sleeve element 20 over the receiver section 11 and, in a second step, the insertion element 30 in the recess 14. With truncated cone-shaped receiver sections 11 as shown in FIG. 3, the first variation is preferably employed, the second variation with types of the anti-skid spike 1, for example when intended to achieve the mushrooming of the base body 10, as shown in FIGS. 5 to 8. The anti-skid spike 1 has essential characteristics as described in this specification and the claims, in variations of the assembly.

Overall, with the described embodiments that a solid connection between the base body 10, the sleeve element 20 and the insertion element 30 is achieved. A cost-effective material selection is also possible. Also, material combinations, which so far have not been or could not be used, can be used or realized.

1. An anti-skid spike (1) which is insertable into an embedding opening in a tread surface (50), having an insertion element (30) made of a hard alloy and a base body (10) with a flange (13) and a recess (14), wherein the insertion element (30) when inserted into the base body (10) protrudes past the base body (10), the anti-skid spike (1) comprising:
the base body (10) forming a receiver section (11) extending at least partially around the recess (14) in the base body (10), and
a sleeve element (20) applied on the receiver section (11) which fixes the insertion element (30) inserted into the recess (14) of the base body (10) in at least one of a positive manner and a non-positive manner.

2. The anti-skid spike (1) in accordance with claim 1, wherein in an assembled state the insertion element (30) projects past the sleeve element (20).

3. The anti-skid spike (1) in accordance with claim 2, wherein the insertion element (30) has a cone-shaped section (33) which, in the assembled state, engages the corresponding recess (14) in the base body (10), and one of a positive connection and a non-positive connection between the sleeve element (20) and the receiver section (11) of the base body (10) is formed.

4. The anti-skid spike (1) in accordance with claim 3, wherein the sleeve element (20) is of a material of a lesser wear resistance relative to the insertion element (30).

5. The anti-skid spike (1) in accordance with claim 4, wherein the base body (10) is made of a material which is less wear-resistant than the insertion element (30) and the sleeve element (20).

6. The anti-skid spike (1) in accordance with claim 5, wherein the sleeve element (20) forms a closed ring resting on an entire surface of the receiver section (11) of the base body (10), as one of a ring partially resting in segments and a clamping sleeve formed as a slit ring.

7. The anti-skid spike (1) in accordance with claim 6, wherein the sleeve element (20) has a bezel (21, 22) at least at one end on a longitudinal side which at least partially encircles.

8. The anti-skid spike (1) in accordance with claim 6, wherein the sleeve element (20) is rotationally symmetrical.

9. The anti-skid spike (1) in accordance with claim 8, wherein a flange (13) is formed on the base body (10), and a diameter of the sleeve element (20) is greater than a second diameter of the flange (13) of the base body (10).

10. The anti-skid spike (1) in accordance with claim 9, wherein the receiver section (11) of the base body (10) and the corresponding passage (23) in the sleeve element (20) are cylindrical.

11. The anti-skid spike (1) in accordance with claim 9, wherein the receiver section (11) of the base body (10) and the corresponding passage (23) in the sleeve element (20) form a truncated cone.

12. The anti-skid spike (1) in accordance with claim 9, wherein the receiver section (11) of the base body (10) is cylindrical, and a corresponding passage (23) of the sleeve element (20) has a form of a truncated cone.

13. The anti-skid spike (1) in accordance with claim 9, wherein the receiver section (11) of the base body (10) has a first section (17) in a shape of a truncated cone and a following cylindrical second section (18), the passage (23) in the sleeve element (20) has an area which corresponds to the first section (17) of the receiver section (11), which is followed by a conically widened expansion depression (25).

14. The anti-skid spike (1) in accordance with claim 13, wherein a detent (12) is formed as a protrusion between the receiver section (11) and the flange (13) of the base body (10).

15. The anti-skid spike (1) in accordance with claim 14, wherein the receiver section (11) of the base body (10) has a snap-in element (15), which in the assembled state engages a snap-in receiver (24) of the sleeve element (20).

16. The anti-skid spike (1) in accordance with claim 15, wherein the receiver section (11) of the base body (10) has a snap-in element (15) and at least one slit-shaped recess (16) in a longitudinal direction of the receiver section (11), and in the assembled state the snap-in element (15) engages a snap-in receiver (24) of the sleeve element (20).

17. The anti-skid spike (1) in accordance with claim 16, wherein the sleeve element (20) is as a multi-part element, and has at least one further ring sleeve element (40).

18. The anti-skid spike (1) in accordance with claim 17, wherein at least one of the sleeve element (20) has a radially outward protruding flange (26) and the base body (10) has at least one further flange (13).

19. The anti-skid spike (1) in accordance with claim 18, wherein in the assembled state the insertion element (30) is set back with respect to the sleeve element (20), and the sleeve element (20) protrudes beyond the tread surface (50).

20. The anti-skid spike (1) in accordance with claim 1, wherein the insertion element (30) has a cone-shaped section (33) which, in an assembled state, engages the corresponding recess (14) in the base body (10), and one of a positive connection and a non-positive connection between the sleeve element (20) and the receiver section (11) of the base body (10) is formed.

21. The anti-skid spike (1) in accordance with claim 1, wherein the sleeve element (20) is of a material of a lesser wear resistance relative to the insertion element (30).

22. The anti-skid spike (1) in accordance with claim 1, wherein the base body (10) is of a material which is less wear-resistant than the insertion element (30) and the sleeve element (20).

23. The anti-skid spike (1) in accordance with claim 1, wherein the sleeve element (20) forms a closed ring resting on an entire surface of the receiver section (11) of the base body (10), as one of a ring partially resting in segments and a clamping sleeve formed as a slit ring.

24. The anti-skid spike (1) in accordance with claim 1, wherein the sleeve element (20) has a bezel (21, 22) at least at one end on a longitudinal side which at least partially encircles.

25. The anti-skid spike (1) in accordance with claim 1, wherein the sleeve element (20) is rotationally symmetrical.

26. The anti-skid spike (1) in accordance with claim 1, wherein a flange (13) is formed on the base body (10), and a diameter of the sleeve element (20) is greater than a second diameter of the flange (13) of the base body (10).

27. The anti-skid spike (1) in accordance with claim 1, wherein the receiver section (11) of the base body (10) and the corresponding passage (23) in the sleeve element (20) are cylindrical.

28. The anti-skid spike (1) in accordance with claim 1, wherein the receiver section (11) of the base body (10) and the corresponding passage (23) in the sleeve element (20) form a truncated cone.

29. The anti-skid spike (1) in accordance with claim 1, wherein the receiver section (11) of the base body (10) is cylindrical, and a corresponding passage (23) of the sleeve element (20) has a form of a truncated cone.

30. The anti-skid spike (1) in accordance with claim 1, wherein the receiver section (11) of the base body (10) has a first section (17) in a shape of a truncated cone and a following cylindrical second section (18), the passage (23) in the sleeve element (20) has an area which corresponds to the first section (17) of the receiver section (11), which is followed by a conically widened expansion depression (25).

31. The anti-skid spike (1) in accordance with claim 1, wherein a detent (12) is formed as a protrusion between the receiver section (11) and the flange (13) of the base body (10).

32. The anti-skid spike (1) in accordance with claim 1, wherein the receiver section (11) of the base body (10) has a snap-in element (15), which in an assembled state engages a snap-in receiver (24) of the sleeve element (20).

33. The anti-skid spike (1) in accordance with claim 1, wherein the receiver section (11) of the base body (10) has a snap-in element (15) and at least one slit-shaped recess (16) in a longitudinal direction of the receiver section (11), and in an assembled state the snap-in element (15) engages a snap-in receiver (24) of the sleeve element (20).

34. The anti-skid spike (1) in accordance with claim 1, wherein the sleeve element (20) is a multi-part element, and has at least one further ring sleeve element (40).

35. The anti-skid spike (1) in accordance with claim 1, wherein at least one of the sleeve element (20) has a radially outward protruding flange (26) and the base body (10) has at least one further flange (13).

36. The anti-skid spike (1) in accordance with claim 1, wherein in the assembled state the insertion element (30) is set back with respect to the sleeve element (20), and the sleeve element (20) protrudes beyond the tread surface (50).
